(19) United States
(12) Patent Application Publication
(10) Pub. No.: US 2019/0384238 A1
(43) Pub. Date: Dec. 19, 2019

(54) BUILDING MANAGEMENT SYSTEM AND METHOD USING LEARNED ENVIRONMENTAL PARAMETERS FOR PROACTIVE CONTROL

(71) Applicant: Siemens Industry, Inc., Alpharetta, GA (US)

(72) Inventor: Pornsak Songkakul, Mequon, WI (US)

(21) Appl. No.: 16/011,114

(22) Filed: Jun. 18, 2018

(51) Int. Cl. G05B 13/04; G05B 13/02; G01W 1/10; F24F 11/63

(52) U.S. Cl. CPC G05B 13/048; F24F 11/63; G01W 1/10; G05B 13/0265

(57) ABSTRACT

Methods for proactive control of area operating conditions (area management) in a building automation system and corresponding systems and computer-readable mediums. A method includes determining anticipated area loads for a plurality of areas of a building. The method includes analyzing the anticipated area loads with respect to a current weather condition and a short term weather forecasting. The method includes identifying proactive control operating data in real time from an operating table for a heating plant and a cooling plant of the building based on the analysis. The method includes controlling the building automation system to adjust physical conditions of at least one area of the building to meet total anticipated area loads.

### TECHNICAL FIELD

The present disclosure is directed, in general, to building-control systems, and in particular to control of automated lighting, heating, cooling, and window blind systems.

### BACKGROUND OF THE DISCLOSURE

Building automation systems encompass a wide variety of systems that aid in the monitoring and control of various aspects of building operation. Building automation systems include security systems, fire safety systems, lighting systems, and HVAC systems. The elements of a building automation system are widely dispersed throughout a facility. For example, an HVAC system may include temperature sensors and ventilation damper controls, as well as other elements that are located in virtually every area of a facility. These building automation systems typically have one or more centralized control stations from which system data may be monitored and various aspects of system operation may be controlled and/or monitored.

To allow for monitoring and control of the dispersed control system elements, building automation systems often employ multi-level communication networks to communicate operational and/or alarm information between operating elements, such as sensors and actuators, and the centralized control station. One example of a building automation system is the DXR Controller, available from Siemens Industry, Inc. Building Technologies Division of Buffalo Grove, Ill. (“Siemens”). In this system, several control stations connected via an Ethernet or another type of network may be distributed throughout one or more building locations, each having the ability to monitor and control system operation. In addition, the control system elements can also incorporate the use of a command button or other user input for occupants to activate to indicate that the condition in space meets their desired operating conditions (e.g., temperature level, ventilation flow, artificial lighting level, and natural lighting level).

### SUMMARY OF THE DISCLOSURE

This disclosure describes proactive area management in a building automation system and corresponding systems and computer-readable mediums. The outcome of the proactive room management is the perfect area environment of which the following conditions that are desired by the occupants are achieved: desired temperature level, desired artificial lighting level, desired natural lighting level, desired ventilation air flow level, and desired exposure to daylight and view.

According to one embodiment, a method includes determining anticipated area loads for a plurality of areas of a building. The method includes analyzing the anticipated area loads with respect to a current weather condition and a short term weather forecasting. The method includes identifying proactive control operating data in current from an operating table for a heating plant and a cooling plant of the building based on the analysis. The method includes controlling the building automation system to adjust physical conditions of at least one area of the building to meet total anticipated area loads.

In various embodiments, the method further includes monitoring ongoing operating conditions and environmental conditions of the at least one area, the cooling plant and the heating plant, updating area profile data for the at least one area according to the ongoing operating conditions and environmental conditions of the at least one area, updating heating plant profile data for the plant according to the ongoing operating conditions of the heating plant, and updating cooling plant profile data for the plant according to the ongoing operating conditions of the cooling plant.

In various embodiments, the heating plant profile data includes historical data for the heating plant, or the cooling plant profile data includes historical data for the cooling plant. In various embodiments, the method further includes analyzing the heating plant profile data or the cooling plant profile data using one or more of machine learning, pattern recognition, or neural network techniques.

In various embodiments, controlling the building automation system includes determining desired occupant thermal comfort and visual comfort in the at least one area. In various embodiments, controlling the building automation system is performed in real time is based on the anticipated area loads. In various embodiments, controlling the building automation system includes at least one of performing chiller on/off sequences, performing boiler on/off sequences, adjusting cooling plant setpoints, or adjusting heating plant setpoints. In various embodiments, the operating table includes operating condition data with respect to environmental and time conditions of the area, including one or more of time of day, day of week, day of year, weather, area occupation status, or sunshine conditions. In various embodiments, the method further includes analyzing the area profile data for the area to produce an operating table for the at least one area, identifying control operating data from the operating table for the at least one area based on the current weather condition and the short term weather forecasting, and controlling the building automation system to adjust physical conditions of the at least one area to meet occupant preference.

In various embodiments, the method further includes monitoring ongoing operating conditions and environmental conditions of the at least one area, and updating the area profile data for the at least one area according to the ongoing operating conditions and environmental conditions of the area. In various embodiments, controlling the building automation system to adjust physical conditions of at least one area is based on an occupancy schedule of the area. In various embodiments, controlling the building automation system to adjust physical conditions of at least one area includes adjusting a temperature setpoint, adjusting a lighting level setpoint, adjusting a fresh air ventilation volume, adjusting a blind opening setpoint, or adjusting a blind angle setpoint. In various embodiments, the area profile data for the at least one area includes historical data for the at least one area and future scheduling data for the at least one area. In various embodiments, the area profile data for the at least one area includes historical data of the interaction between area occupants and the field device in the at least one area.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a building automation system in which the energy efficiency of a heating, ventilation, and air conditioning (HVAC) system may be improved in accordance with the present disclosure;

FIG. 2 illustrates details of one of the field panels of FIG. 1 in accordance with the present disclosure;

FIG. 3 illustrates details of one of the field controllers of FIG. 1 in accordance with the present disclosure;

FIG. 4 illustrates a block diagram of a room that can be managed using disclosed techniques;

FIG. 5 illustrates an example of a floor of a building with various areas, in accordance with disclosed embodiments;

FIG. 6 illustrates a flowchart of major processes in accordance with disclosed embodiments;

FIG. 7 illustrates an example of data collected in this process to collect existing control operating data and the occupants desired operating conditions of the room, in accordance with disclosed embodiments;

FIG. 8 illustrates an example of a process of analyzing data to build or refine operating tables in accordance with disclosed embodiments;

FIG. 9 illustrates an example of proactive control of area operating conditions based on area operating table(s) in accordance with disclosed embodiments;

FIG. 10 illustrates an example of proactive control of plant operating conditions based on plant operating table(s) in accordance with disclosed embodiments;

FIG. 11 illustrates a flowchart of a process in accordance with disclosed embodiments; and

FIG. 12 illustrates a block diagram of a data processing system 1200 in which various embodiments can be implemented.

### DETAILED DESCRIPTION

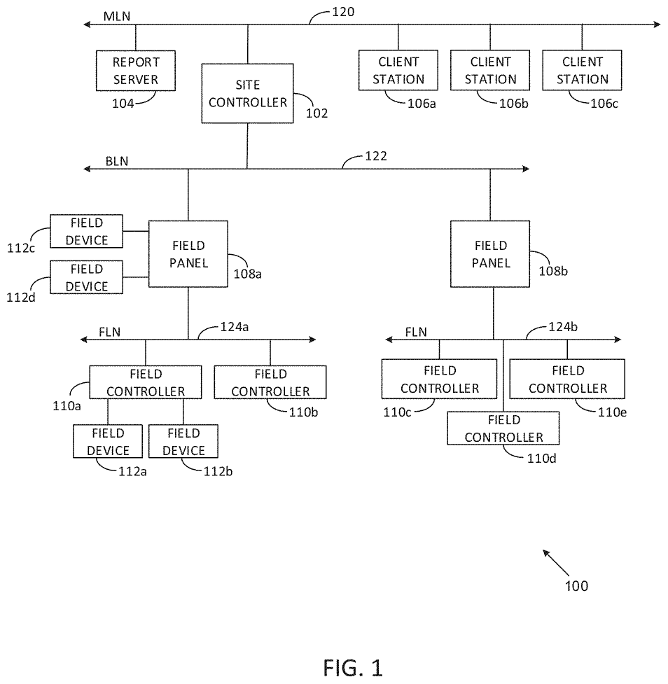

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

A building automation system (BAS) such as disclosed herein can operate in an automatic operation mode that helps operate systems in the space efficiently to save energy. The BAS continuously evaluates environmental conditions and energy usage in the space, and can determine and indicate to users when the space is being operated most efficiently. Similarly, the BAS can determine and indicate when the systems operate inefficiently, such as due to an occupant overriding the room control because of personal preference or due to weather conditions change drastically. The BAS can automatically, or at the input of a user, adjust the control settings to make the systems operate efficiently again.

Disclosed embodiments include systems and methods for proactive room control for the rooms, zones, or other areas in a building, including perimeter building zones that have facades with windows with operable blinds and interior spaces. As used herein, an “area” of the building refers to a room, zone, workspace, meeting space, or other physical portions of a building, whether or not physically divided from other areas, for which processes as described can be performed. “Proactive” control refers to proactively providing acceptable lighting and thermal comfort conditions that meet occupant's preference while efficiently operating the environmental control systems. Occupant comfort in a building environment can include both thermal comfort (temperature and relative humidity in the right range) and good lighting conditions (which includes absence or minimization of glare), as well as factors such as views from windows. Daylighting, the control of illumination from daylight, can be adjusted by means of controlling the opening of window blinds and the angle of window blinds slats. The use of daylighting in building designs is increasingly being recognized as a primary way to not only reduce electrical lighting energy consumption in buildings but to enhance indoor environmental quality (IEQ) for the people (workers) present in the building. When designing for maximum daylight, designers must evaluate and balance a number of environmental factors, such as heat gain and loss, glare control, visual quality, and variations in daylight availability. Daylighting can enhance IEQ in several ways: by providing a natural view to the outdoors, providing natural daylight to work surfaces, and reducing glare from electrical lighting. Studies have shown that when IEQ is enhanced, worker productivity increases, student test scores increase, and absenteeism is reduced.

Offices with sufficient natural daylight and a visual connection to the outdoors have been proven to increase occupant productivity and comfort, leading to better employee retention and reduced absenteeism. Successful daylighting designs use can use diffuse light from the sky through both skylights and window facades, and use daylighting as the primary source of illumination inside a building, and can be adjusted to accommodate factors such as desirable outside views. Successful daylighting designs when the daylighting controls are integrated with the electric lighting system provide not only electrical lighting energy savings, but a quality visual environment, with worker productivity increases and reduced absenteeism.

Window blind systems can be used to control daylight into a perimeter space by controlling the opening area of slats and by controlling the tilt angle of the slats relative to the position of the sun in the sky and the effect of reflection from the nearby buildings and structures. In general, maximizing daylighting will minimize the need for electric lighting, and while the maximizing of daylighting will reduce heating loads in winter (the heating season), the solar heat gain through windows will also increase cooling loads in summer (the cooling season). In addition, in an office environment, direct daylighting into a space can also cause glare, and minimization of glare must be included along with thermal comfort as a priority to provide a comfortable environment for employees.

Some building management systems can integrate lighting and daylighting controls with HVAC controls and other controls to minimize total energy consumption while maintaining occupant comfort and preferences. Perimeter zones gain heat and light by the influx of solar radiation through the window blinds, which must be removed by cooling (or less heating) energy supplied to the space. Cooling and heating the space can be supplied by a variety of methods, depending on the type of HVAC supply air distribution system and terminal heating/cooling equipment.

In general, maximizing daylighting in a perimeter zone during the cooling season will minimize the need for electric lighting, but may increase cooling loads in the zone to maintain the required space temperature conditions, and may cause glare. Similarly, maximizing daylighting in a perimeter zone during the heating season will minimize the need for electric lighting and reduce heating loads, but may cause occupant discomfort from direct sunlight penetrating deep into the space due to the relatively low position of the sun in wintertime as it arches across the sky.

Disclosed embodiments gathering data to construct data tables and events that record operation data and control settings for rooms or zones in a building managed by the BAS. The operation data and control settings reflect the actual operating conditions of the room according to BAS control, user preferences/changes, the energy consumed by the room, and the external environmental conditions, such as weather or exterior lighting, that affect the room conditions. The system can transform this data into an operations table that allows year-round proactive controlling of the room environment, where time of day and time of year can be used along with actual weather data and short term forecast weather data to dictate control decisions to achieve operating conditions for each room that meet occupant comfort and preferences while efficiently operating the system.

For example, at any time of day, based on weather condition and sensing values, the BAS can use the knowledge from the operation table to automatically make adjustment to the temperature, lighting, window blind, or other set points to meet the occupant desired operating condition and at the same time achieving energy efficient operation of the BAS for most rooms at all time.

As another example, the BAS can reducing the time for the system to operate to most efficiently at any given time by observing the necessary conditions and taking proactive control actions before occupants need to take any actions. This proactive control results in an operation of the BAS to achieve occupant desired operating conditions in each room while balancing the needs for energy efficient operation.

A BAS as disclosed herein can use machine-learning and other heuristic techniques to learn from the dataset and to establish or refine operating tables for both room operating conditions and plant operating conditions to maintain the desired occupant comfort requirements in any room while maintaining efficient operation of the energy systems. In addition, as more operating data are collected, machine learning and other heuristic techniques can be used to improve the operating table to account for the dynamic changes in buildings, building infrastructure, and building systems.

FIG. 1 illustrates a block diagram of a building automation system 100 in which disclosed embodiments can be implemented. The building automation system 100 is an environmental control system configured to control at least one of a plurality of environmental parameters within a building, such as temperature, humidity, lighting and/or the like. For example, for a particular embodiment, the building automation system 100 may comprise the DXR Controller building automation system that allows the setting and/or changing of various controls of the system. While a brief description of the building automation system 100 is provided below, it will be understood that the building automation system 100 described herein is only one example of a particular form or configuration for a building automation system and that the system 100 may be implemented in any other suitable manner without departing from the scope of this disclosure.

For the illustrated embodiment, the building automation system 100 comprises a site controller 102, a report server 104, a plurality of client stations 106a-c, a plurality of field panels 108a-b, a plurality of field controllers 110a-e and a plurality of field devices 112a-d. Although illustrated with three client stations 106, two field panels 108, five field controllers 110 and four field devices 112, it will be understood that the system 100 may comprise any suitable number of any of these components 106, 108, 110 and 112 based on the particular configuration for a particular building.

The site controller 102, which may comprise a computer or a general-purpose processor, is configured to provide overall control and monitoring of the building automation system 100. The site controller 102 may operate as a data server that is capable of exchanging data with various elements of the system 100. As such, the site controller 102 may allow access to system data by various applications that may be executed on the site controller 102 or other supervisory computers (not shown in FIG. 1).

For example, the site controller 102 may be capable of communicating with other supervisory computers, Internet gateways, or other gateways to other external devices, as well as to additional network managers (which in turn may connect to more subsystems via additional low-level data networks) by way of a management level network (MLN) 120. The site controller 102 may use the MLN 120 to exchange system data with other elements on the MLN 120, such as the report server 104 and one or more client stations 106. The report server 104 may be configured to generate reports regarding various aspects of the system 100. Each client station 106 may be configured to communicate with the system 100 to receive information from and/or provide modifications to the system 100 in any suitable manner. The MLN 120 may comprise an Ethernet or similar wired network and may employ TCP/IP, BACnet, and/or other protocols that support high-speed data communications.

The site controller 102 may also be configured to accept modifications and/or other input from a user. This may be accomplished via a user interface of the site controller 102 or any other user interface that may be configured to communicate with the site controller 102 through any suitable network or connection. The user interface may include a keyboard, touchscreen, mouse, or other interface components. The site controller 102 is configured to, among other things, affect or change operational data of the field panels 108, as well as other components of the system 100. The site controller 102 may use a building level network (BLN) 122 to exchange system data with other elements on the BLN 122, such as the field panels 108.

Each field panel 108 may comprise a general-purpose processor and is configured to use the data and/or instructions from the site controller 102 to provide control of its one or more corresponding field controllers 110. While the site controller 102 is generally used to make modifications to one or more of the various components of the building automation system 100, a field panel 108 may also be able to provide certain modifications to one or more parameters of the system 100. Each field panel 108 may use a field level network (FLN) 124 to exchange system data with other elements on the FLN 124, such as a subset of the field controllers 110 coupled to the field panel 108.

Each field controller 110 may comprise a general-purpose processor and may correspond to one of a plurality of localized, standard building automation subsystems, such as building space temperature control subsystems, lighting control subsystems, or the like. For a particular embodiment, the field controllers 110 may comprise the model DXR controller available from Siemens. However, it will be understood that the field controllers 110 may comprise any other suitable type of controllers without departing from the scope of the present invention.

To carry out control of its corresponding subsystem, each field controller 110 may be coupled to one or more field devices 112. Each field controller 110 is configured to use the data and/or instructions from its corresponding field panel 108 to provide control of its one or more corresponding field devices 112. For some embodiments, some of the field controllers 110 may control their subsystems based on sensed conditions and desired set point conditions. For these embodiments, these field controllers 110 may be configured to control the operation of one or more field devices 112 to attempt to bring the sensed condition to the desired set point condition. It is noted that in the system 100, information from the field devices 112 may be shared between the field controllers 110, the field panels 108, the site controller 102 and/or any other elements on or connected to the system 100. In specific embodiments described herein, field devices 112 can include blind controllers that control window opening area (by moving the slats up and down) and window blind tilt angles (the tilt of the slats of window blinds as measured from vertical), glass controllers for controlling electrochromatic glass, temperature sensors, lighting/illumination controls or sensors, beam detectors that detect direct sunlight, and others. In some embodiments, the thermal environment of a room can be measured by dry bulb temperature and relative humidity sensors that functions a field devices 112. Note that “blind controllers” and blind functions and setpoints are intended to include operation of both shades (that only open/close the cover over the window or other opening) and blinds (that can both open/close and adjust blind angles).

In order to facilitate the sharing of information between subsystems, groups of subsystems may be organized into an FLN 124. For example, the subsystems corresponding to the field controllers 110a and 110b may be coupled to the field panel 108a to form the FLN 124a. The FLNs 124 may each comprise a low-level data network that may employ any suitable proprietary or open protocol.

Each field device 112 may be configured to measure, monitor and/or control various parameters of the building automation system 100. Examples of field devices 112 include lights, thermostats, temperature sensors, lighting sensors, fans, damper actuators, heaters, chillers, alarms, HVAC devices, window blind controls and sensors, and numerous other types of field devices. The field devices 112 may be capable of receiving control signals from and/or sending signals to the field controllers 110, the field panels 108 and/or the site controller 102 of the building automation system 100. Accordingly, the building automation system 100 is able to control various aspects of building operation by controlling and monitoring the field devices 112.

For specific field devices 112, such as thermostats or other field devices in an area of the building that support user inputs, occupants can interact with such field device and enter their desired room operating conditions including the setpoint of the temperature, the setpoint of the artificial lighting level, and the setpoint of the opening and the angle of the shades and blinds. In addition, for field device such as the QMX series of room sensors/controllers available from Siemens, occupants are provided with a special command button to allow users to command the field device to enter the energy efficient operating mode. For the QMX series of room sensors/controllers available from Siemens, there is a “Green Leaf” command button to allow occupants to signal the controller to operate in the energy efficient mode. Observing and collecting data related to the interaction between occupant and field device 112 along with actual operating conditions significantly contribute to the understanding of occupant comfort preference under various weather conditions.

As illustrated in FIG. 1, any of the field panels 108, such as the field panel 108a, may be directly coupled to one or more field devices 112, such as the field devices 112c and 112d. For this type of embodiment, the field panel 108a may be configured to provide direct control of the field devices 112c and 112d instead of control via one of the field controllers 110a or 110b. Therefore, for this embodiment, the functions of a field controller 110 for one or more particular subsystems may be provided by a field panel 108 without the need for a field controller 110.

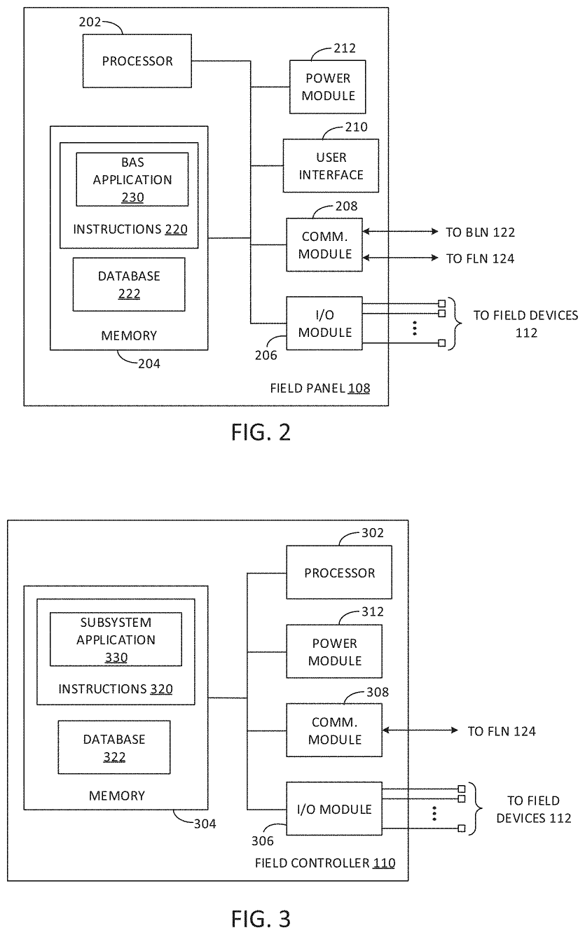

FIG. 2 illustrates details of one of the field panels 108 in accordance with the present disclosure. For this particular embodiment, the field panel 108 comprises a processor 202, a memory 204, an input/output (I/O) module 206, a communication module 208, a user interface 210 and a power module 212. The memory 204 comprises any suitable data store capable of storing data, such as instructions 220 and a database 222. It will be understood that the field panel 108 may be implemented in any other suitable manner without departing from the scope of this disclosure.

The processor 202 is configured to operate the field panel 108. Thus, the processor 202 may be coupled to the other components 204, 206, 208, 210 and 212 of the field panel 108. The processor 202 may be configured to execute program instructions or programming software or firmware stored in the instructions 220 of the memory 204, such as BAS application software 230. In addition to storing the instructions 220, the memory 204 may also store other data for use by the system 100 in the database 222, such as various records and configuration files, graphical views and/or other information.

Execution of the BAS application 230 by the processor 202 may result in control signals being sent to any field devices 112 that may be coupled to the field panel 108 via the I/O module 206 of the field panel 108. Execution of the BAS application 230 may also result in the processor 202 receiving status signals and/or other data signals from field devices 112 coupled to the field panel 108 and storage of associated data in the memory 204. In one embodiment, the BAS application 230 may be provided by or implemented in the DXR Controller commercially available from Siemens Industry, Inc. However, it will be understood that the BAS application 230 may comprise any other suitable BAS control software.

The I/O module 206 may comprise one or more input/output circuits that are configured to communicate directly with field devices 112. Thus, for some embodiments, the I/O module 206 comprises analog input circuitry for receiving analog signals and analog output circuitry for providing analog signals.

The communication module 208 is configured to provide communication with the site controller 102, other field panels 108 and other components on the BLN 122. The communication module 208 is also configured to provide communication to the field controllers 110, as well as other components on the FLN 124 that is associated with the field panel 108. Thus, the communication module 208 may comprise a first port that may be coupled to the BLN 122 and a second port that may be coupled to the FLN 124. Each of the ports may include an RS-485 standard port circuit or other suitable port circuitry.

The field panel 108 may be capable of being accessed locally via the interactive user interface 210. A user may control the collection of data from field devices 112 through the user interface 210. The user interface 210 of the field panel 108 may include devices that display data and receive input data. These devices may be permanently affixed to the field panel 108 or portable and moveable. For some embodiments, the user interface 210 may comprise an LCD-type screen or the like and a keypad. The user interface 210 may be configured to both alter and show information regarding the field panel 108, such as status information and/or other data pertaining to the operation of, function of and/or modifications to the field panel 108.

The power module 212 may be configured to supply power to the components of the field panel 108. The power module 212 may operate on standard 120 volt AC electricity, other AC voltages or DC power supplied by a battery or batteries.

FIG. 3 illustrates details of one of the field controllers 110 in accordance with the present disclosure. For this particular embodiment, the field controller 110 comprises a processor 302, a memory 304, an input/output (I/O) module 306, a communication module 308 and a power module 312. For some embodiments, the field controller 110 may also comprise a user interface (not shown in FIG. 3) that is configured to alter and/or show information regarding the field controller 110. The memory 304 comprises any suitable data store capable of storing data, such as instructions 320 and a database 322. It will be understood that the field controller 110 may be implemented in any other suitable manner without departing from the scope of this disclosure. For some embodiments, the field controller 110 may be positioned in, or in close proximity to, a room of the building where temperature or another environmental parameter associated with the subsystem may be controlled with the field controller 110.

The processor 302 is configured to operate the field controller 110. Thus, the processor 302 may be coupled to the other components 304, 306, 308 and 312 of the field controller 110. The processor 302 may be configured to execute program instructions or programming software or firmware stored in the instructions 320 of the memory 304, such as subsystem application software 330. For a particular example, the subsystem application 330 may comprise a temperature control application that is configured to control and process data from all components of a temperature control subsystem, such as a temperature sensor, a damper actuator, fans, and various other field devices. In addition to storing the instructions 320, the memory 304 may also store other data for use by the subsystem in the database 322, such as various configuration files and/or other information.

Execution of the subsystem application 330 by the processor 302 may result in control signals being sent to any field devices 112 that may be coupled to the field controller 110 via the I/O module 306 of the field controller 110. Execution of the subsystem application 330 may also result in the processor 302 receiving status signals and/or other data signals from field devices 112 coupled to the field controller 110 and storage of associated data in the memory 304.

The I/O module 306 may comprise one or more input/output circuits that are configured to communicate directly with field devices 112. Thus, for some embodiments, the I/O module 306 comprises analog input circuitry for receiving analog signals and analog output circuitry for providing analog signals.

The communication module 308 is configured to provide communication with the field panel 108 corresponding to the field controller 110 and other components on the FLN 124, such as other field controllers 110. Thus, the communication module 308 may comprise a port that may be coupled to the FLN 124. The port may include an RS-485 standard port circuit or other suitable port circuitry.

The power module 312 may be configured to supply power to the components of the field controller 110. The power module 312 may operate on standard 120 volt AC electricity, other AC voltages, or DC power supplied by a battery or batteries.

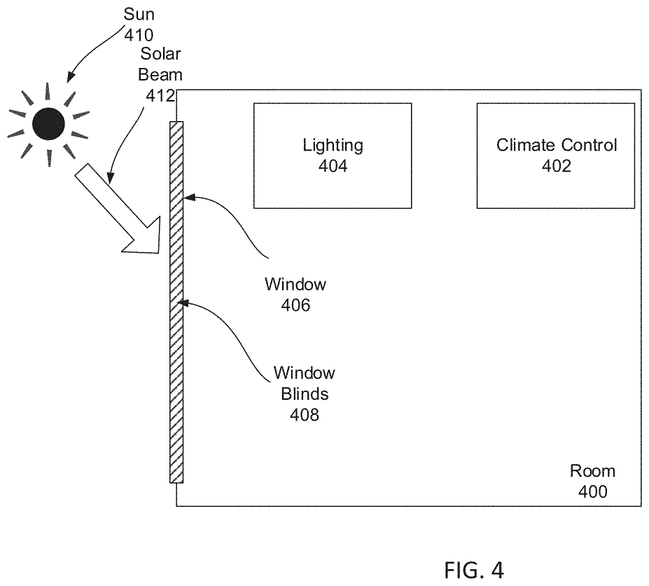

FIG. 4 illustrates a block diagram of a room 400 that can be managed using disclosed techniques. Room 400 is an example of an “area” as discussed herein, and includes climate control 402, which can include heating, cooling, and ventilation systems, all of which consume energy, and which can regulate the temperature and humidity of room 400. Room 400 also includes lighting 404, which consumes energy, and which can be varied in illumination depending on the natural light in the room. Room 400 has a window 406 with window blinds 408. The sun 410 can illuminate room 400 through window 406, and the amount of illumination can be adjusted using window blinds 408. Room 400 can lose heat or gain heat through window 406, depending on weather conditions, the sun 410, the window blinds 408, and other factors. When the sun 410 has a solar beam 412 (direct sunlight) into window 406, glare in room 400 can be a significant problem, but disclosed embodiments can adjust window blinds 408 to control glare, to manage a view from the window, and for other purposes. Climate control 402 can be implemented as an HVAC system as disclosed herein, including room-mounted units such as a variable air volume (VAV) box with reheat coil.

To measure and control the conditions of room 400, the BAS can use real-time data such as measurement of lighting intensity, lighting control level setpoints, room temperature, room temperature setpoints, blind opening control levels, blind angle control level, blind angle setpoints, occupancy status, CO₂ measurements, and others. Other environmental parameters that can be collected include time of day, day of year, day of week. The other environmental parameters can include outside weather conditions including but not limited to outside air temperature, outside air humidity, wind direction, wind speed, and sky condition, all of which can be captured or sensed using known techniques. Room internal load data can also be collected based on the status of an occupancy sensor, time of day, day of week, and an operating schedule for the room, the building, or the business that uses the room. As the actual lighting intensity level is measured in the room, the measured value can reflect such parameters as the effect of light obstruction from the nearby buildings, the effect of light reflection from nearby building, the sky condition, and the sun position for that time of day and day of year. Characteristics of the each room can be stored, such as the building occupancy schedule, room floor area, room volume, room location, room window facing direction, and others. Any of this data, and other data, can be stored as room profile data, for example, in database 222, database 322, or other database in a memory or storage of any of the devices or elements of FIG. 1.

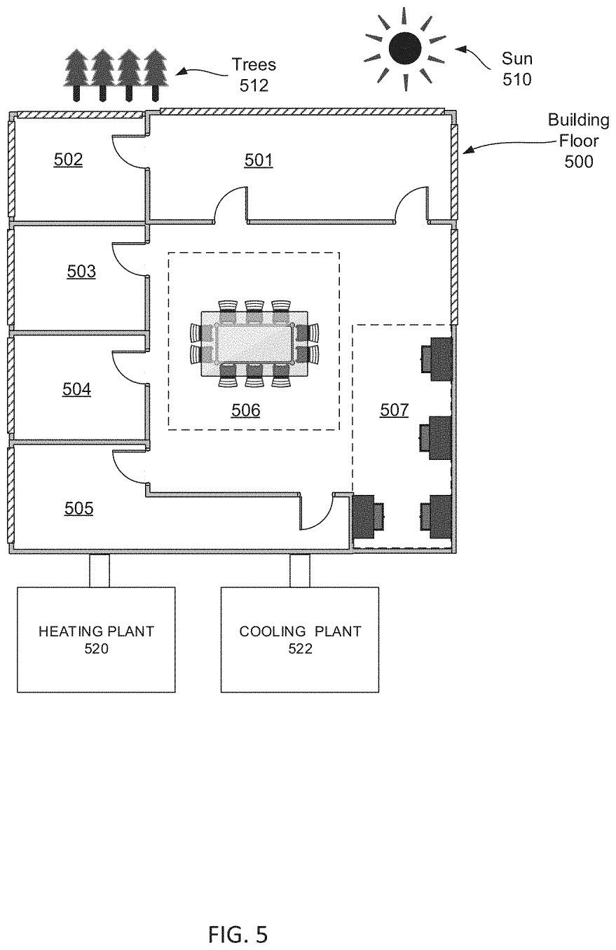

FIG. 5 illustrates an example of a floor 500 of a building with various areas, in accordance with disclosed embodiments. In this example, areas 501-505 each correspond to an individual room or office. The larger open space has two different areas, namely conference area 506 and workstation area 507. As described above, the area can be a room or portion of a room controlled as described herein. Each area may be subject to different environmental or weather factors. For example, areas with windows are more affected by weather, sunlight, exterior temperature, and exterior lighting. In FIG. 5, for example, area 501 has windows exposed to direct sunlight from sun 510, while area 502 has windows shaded by trees 512. Other areas, for example area 503, might not have direct sunlight but receive sunlight reflected off of other buildings. Different areas might have different amounts of air circulation or heat generations (for example, computers in workstation area 507). The current or normal occupants of an area may have different comfort preferences.

FIG. 5 also illustrates that a heating plant 520 and cooling plant 522 are configured to provide heating, cooling, and other HVAC services to the floor 500 of the building. In a typical implementation, a BAS as described above can operate heating plant 520 and cooling plant 522, along with the ducting/ventilation system, to adjust the physical conditions of any of the areas in the building.

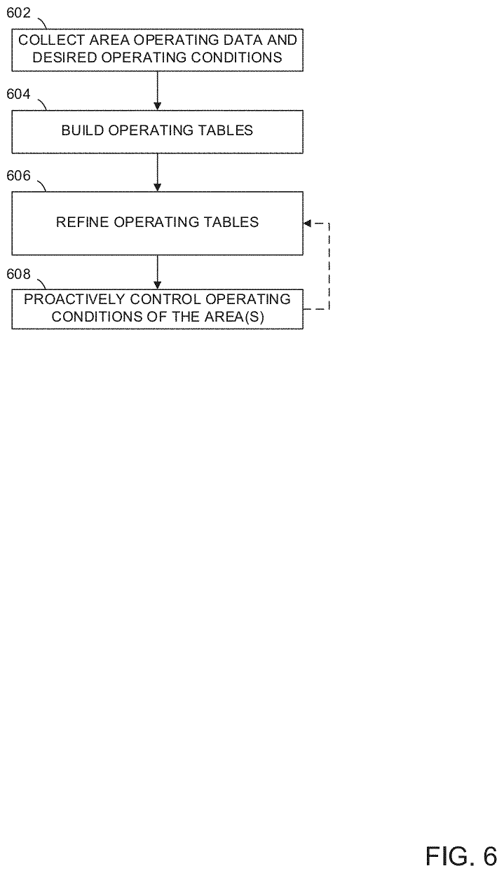

FIG. 6 illustrates a flowchart of major processes in accordance with disclosed embodiments for proactively controlling room conditions in a building automation system. Each process can be performed by a BAS or data processing system such as building automation system 100, which is referred to generically as the “system” below.

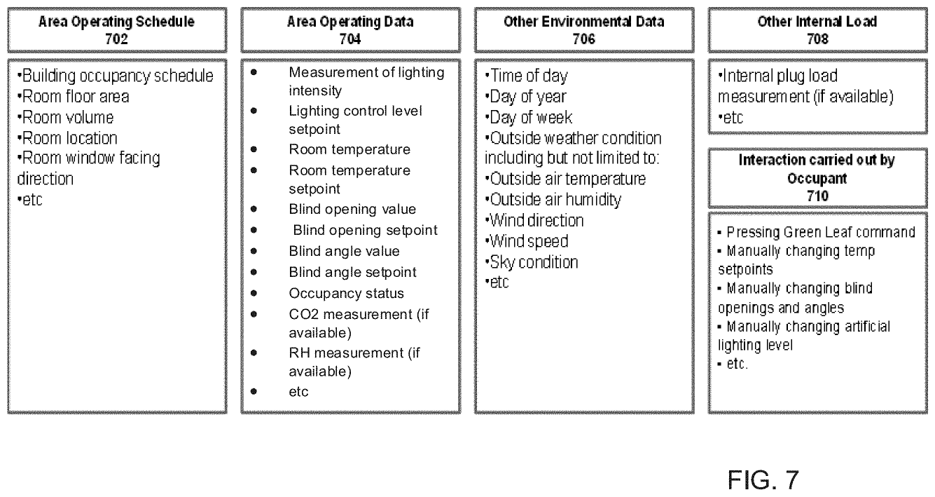

The system collects area operating data and occupants' desired operating conditions of each area (602). FIG. 7 illustrates an example of data collected in this process to collect existing control operating data and the occupants desired operating conditions of the room, which can include an area operating schedule 702, area operating data 704, other environmental data 706, other internal load data 708, and interactions carried out by occupant 710. Interactions carried out by occupant 710 can include user interaction with the controller such as the interaction with the Green Leaf button on a QMX sensor/room unit can also be collected during this process.

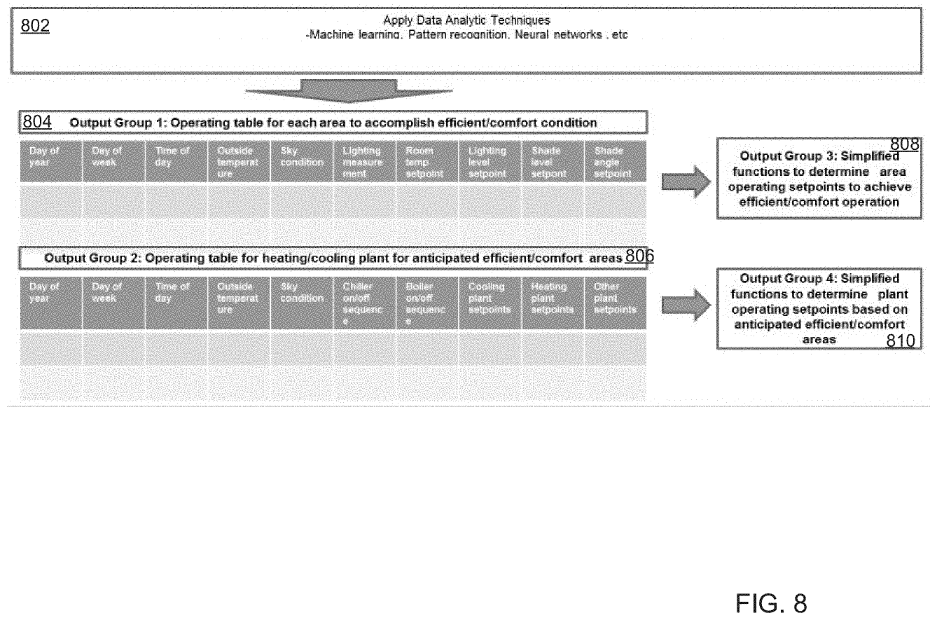

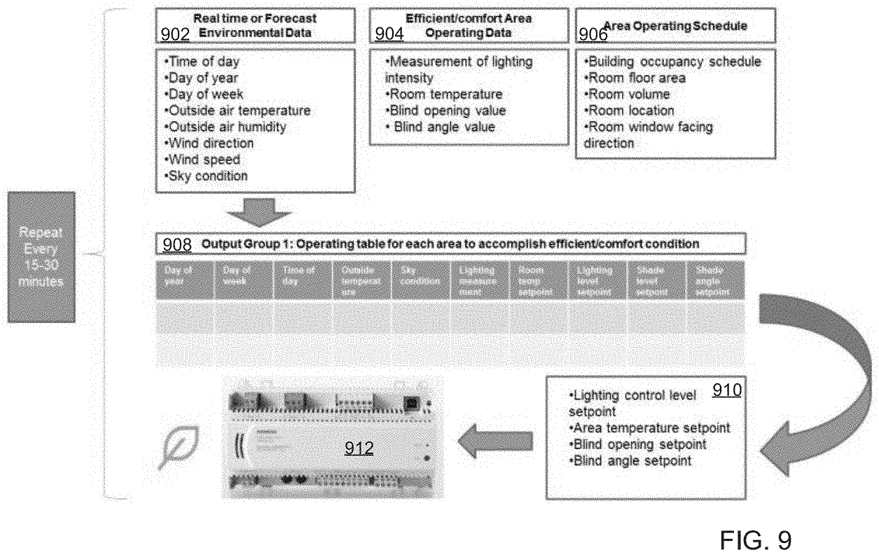

The system applies machine learning and other data heuristic techniques to the operating data and occupants' desired operating conditions to build operating tables for each area and an operating table for plant operation (604). In this process, the system analyzes the collected data for all the areas to produce an operating table for all the areas. This can include area profile data that includes such data as historical and current operating data, scheduling data, desired operating conditions, and factors that affect the area. This can include plant profile data that includes such data as historical data for the plant for the heating plant and/or cooling plant. Machine learning and other heuristic techniques are used for analyzing all the data. This process is used to build and store operating tables for proactive controlling each area operating condition and operating tables for proactive controlling of the heating and cooling plants. FIG. 8 shows an example of this process, where data analytic techniques are applied at 802, to produce outputs such as those shown at 804, 806, 808, and 810. The “efficient/comfort” conditions and areas can be “Green Leaf” conditions or areas as described herein.

The operating table for the room defines BAS operating conditions (e.g., setpoints or other operating condition data) with respect to environmental and time conditions. For example, an operating table can define that at 3 pm on a weekday on August 10, on a sunny day when the room is occupied, the window blinds should be set at a specific angle relative to vertical to reduce external heating and glare but allow daylighting, and HVAC setpoints should be set to specific temperature and airflow setpoints to make the room comfortable, while operating at optimal energy efficiency. Of course, this is not limiting to the data in the operating table; the operating table for a room can include any operating condition data with respect to environmental and time conditions such as time of day, day of week, day of year, weather, room occupation status, sunshine conditions, etc.

The operating table for the heating and cooling plants defines BAS operating conditions (e.g., setpoints or other operating condition data) with respect to environmental and time conditions to satisfy the heating and cooling needs based on the proactive controlling strategy for the room environment.

The system uses the operating tables derived in the second process to identify all the control setpoints to proactively control the room environment that satisfy the occupants preference based on the knowledge derived from data collection described in [0052].

Once the operating tables have been setup, control parameters needed for proactively controlling the room can be identified as functions of day-of-year, time-of-year, weather conditions, occupancy schedule, and occupant preference of room operating conditions. The proactive operating conditions can be functions of various data in the operating table, such as:
Room Temperature Setpoint=function(day-of-year, time-of-year, room location, environmental data, occupancy status, occupancy schedule, occupant temperature preference, etc.);
Lighting Level Setpoint=function(day-of-year, time-of-year, environmental data, occupancy status, occupancy schedule, occupant artificial lighting level preference, etc.);
Blind Opening Setpoint=function(day-of-year, time-of-year, environmental data, occupancy status, occupancy schedule, occupant daylighting level preference, occupant external view exposure reference, etc.); and
Blind Angle Setpoint=function(day-of-year, time-of-year, environmental data, occupancy status, occupancy schedule, occupant daylighting level preference, occupant external view exposure reference, etc.)

The system applies machine learning and other heuristic techniques to refine operating tables for area operating conditions and plant operating conditions (606). In practice, this can be continuing to collect data as in 602, and performing further analysis as in 604, using the existing operating tables and plant operating conditions, to update and refine the operating tables and plant operating conditions to reflect actual operations. The system monitors the actual ongoing operating conditions and environmental conditions of the areas. Using sensors as described herein, the system monitors the environmental conditions such as temperature, lighting, and other factors, including any user adjustments to the operating conditions. The system updates the operating tables and plant operating condition for the area(s) according to the monitored ongoing operating conditions and environmental conditions of the areas.

The system proactively controls the operating condition of the area(s) based on the operating tables (608). Based on proactive operating conditions of all the areas, anticipated heating and cooling loads that must be satisfied by the heating and cooling plants can be calculated from the summation of all the area loads. Proactive operating conditions of the heating and cooling plants including setpoints and number of chillers and boilers that must be turned on to satisfy the anticipating room load can be determined from the heating and cooling plant operating tables. The proactive operating conditions of heating and cooling plants include operating conditions such as chiller on/off sequences, boiler on/off sequences, cooling plant setpoints, heating plant setpoints, related plant equipment on/off sequences, or related plant equipment setpoints.

FIG. 9 illustrates a non-limiting example of proactive control of area operating conditions based on area operating table(s). This example uses real-time or forecast environmental data 902, efficient/comfort area operating data 904, and area operating schedule 906 to build operating table(s) 908. The system uses operating table 908 to proactively set setpoints 910 of controller 912. Current and short term weather forecast data (data for the next 15 minutes up to an hour in advance) can be used for looking up area operating setpoints for proactive control of the area. Proactive control setpoints are then sent to the controller 912 for execution of proactive control strategies.

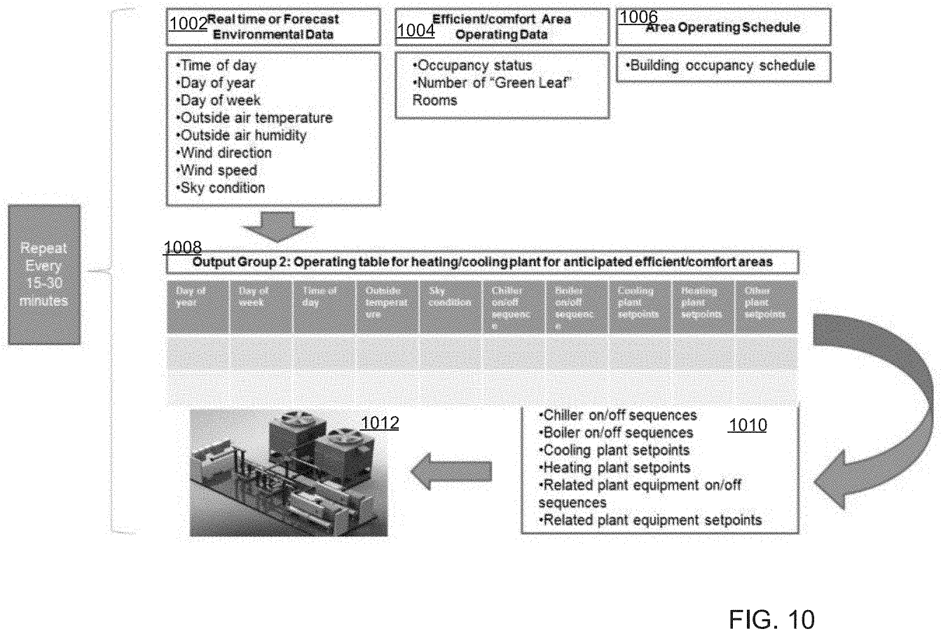

FIG. 10 illustrates a non-limiting example of proactive control of plant operating conditions based on plant operating table(s). This example uses real-time or forecast environmental data 1002, efficient/comfort area operating data 1004, and area operating schedule 1006 to build operating table(s) 1008. The system uses operating table 1008 to proactively set setpoints and sequences 1010 to control controller heating/cooling plants 1012. Once proactive control decisions are made, current and short term weather forecast data (data for the next 15 minutes up to an hour in advance) can be used for looking operating setpoints and sequences for heating and cooling plants from the plant operating table(s).

In this way, not only is the system able to improve the accuracy of the operating table to provide better proactive control, but the area profile data is repeatedly updated so that the system “learns” such characteristics as the response of the room to the specific environmental conditions, changes in user preferences, the environmental conditions on specific days and times, changes in surrounding environment, and other data. The analysis described above provides the technical advantages of machine learning, while the data refinement loop ensures that the system can most accurately model the room for given conditions. This result in a significant improvement in the operation of the building automation system in terms of maintaining each room with environmental conditions that consistently meet the occupant desired operating condition while making energy operation very efficient.

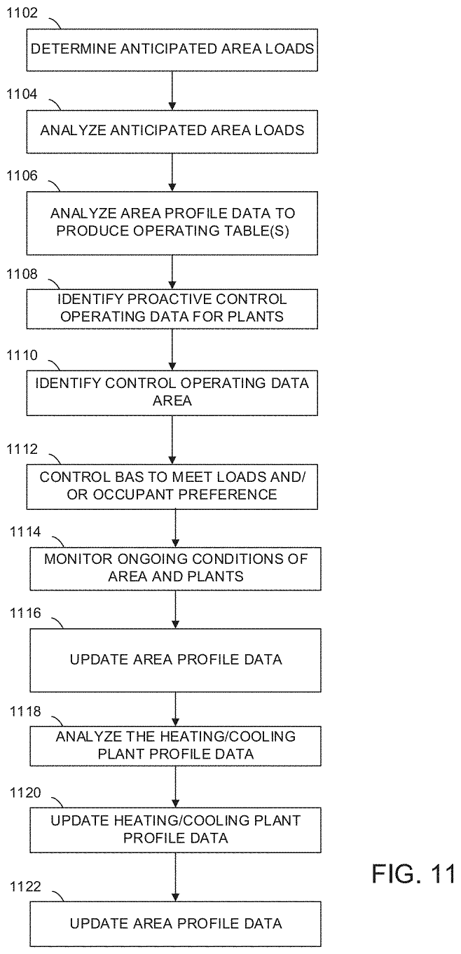

FIG. 11 illustrates a flowchart of a process in accordance with disclosed embodiments that can be performed by a BAS or data processing system such as building automation system 100, which is referred to generically as the “system” below.

The system determines anticipated area loads for a plurality of areas of a building (1102).

The system analyzes the anticipated area loads with respect to a current weather condition and a short term weather forecasting (1104).

The system analyzes the area profile data for the area to produce an operating table for the at least one area (1106). The operating table can include operating condition data with respect to environmental and time conditions of the area, including one or more of time of day, day of week, day of year, weather, area occupation status, or sunshine conditions.

The system identifies proactive control operating data in current from an operating table for a heating plant and a cooling plant of the building based on the analysis (1108).

The system identifies control operating data from the operating table for the at least one area based on the current weather condition and the short term weather forecasting (1110).

The system controls the building automation system to adjust physical conditions of at least one area of the building to meet total anticipated area loads and/or occupant preference (1112). In some case, this can include determining desired occupant thermal comfort and visual comfort in the at least one area. In some case, this can include at least one of performing chiller on/off sequences, performing boiler on/off sequences, adjusting cooling plant setpoints, or adjusting heating plant setpoints. based on an occupancy schedule of the area. In some case, this can include adjusting a temperature setpoint, adjusting a lighting level setpoint, adjusting a fresh air ventilation volume, adjusting a blind opening setpoint, adjusting a blind angle setpoint, or adjusting the light transmission of electrochromatic glass.

The system monitors ongoing operating conditions and environmental conditions of the at least one area, the cooling plant and the heating plant (1114).

The system updates area profile data for the at least one area according to the ongoing operating conditions and environmental conditions of the at least one area (1116). In some cases, the area profile data for the at least one area includes historical data for the at least one area and future scheduling data for the at least one area. In some cases, the area profile data for the at least one area includes historical data of the interaction between area occupants and the field device in the at least one area.

The system analyzes the heating plant profile data or the cooling plant profile data using one or more of machine learning, pattern recognition, or neural network techniques (1118).

The system updates heating/cooling plant profile data for the heating/cooling plants according to the ongoing operating conditions of the heating/cooling plants (1120). In some cases, the heating plant profile data includes historical data for the heating plant. In some cases, the cooling plant profile data includes historical data for the cooling plant.

The system updates the area profile data for the at least one area according to the ongoing operating conditions and environmental conditions of the area (1122). Once the area profile data is updated, the processes in accordance with disclosed embodiments can repeat from (1102) to (1122).

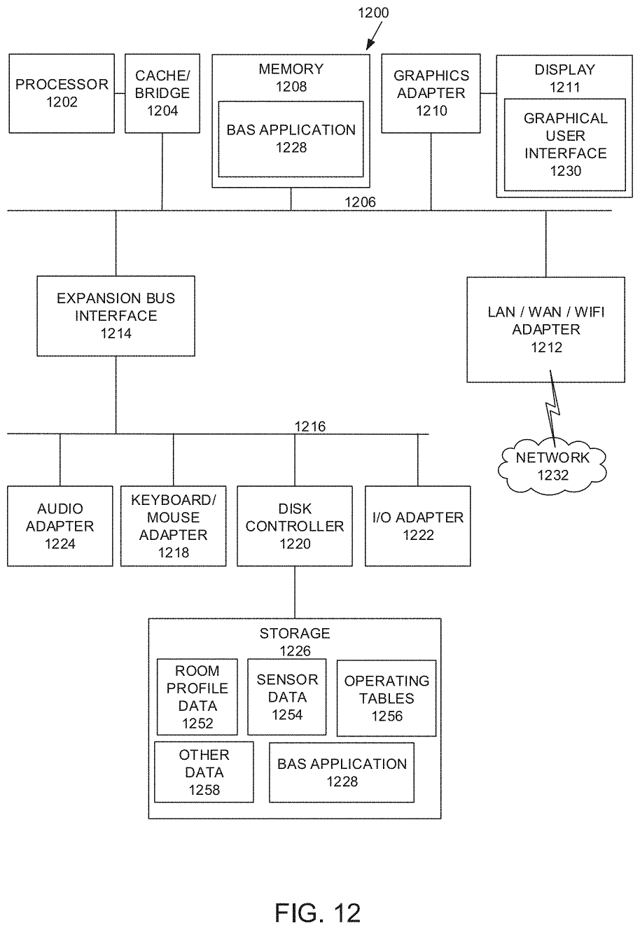

FIG. 12 illustrates a block diagram of a data processing system 1200 in which various embodiments can be implemented. The data processing system 1200 is an example of one implementation of the server data processing system 102 in FIG. 1.

The data processing system 1200 includes a processor 1202 connected to a level two cache/bridge 1204, which is connected in turn to a local system bus 1206. The local system bus 1206 may be, for example, a peripheral component interconnect (PCI) architecture bus. Also connected to the local system bus 1206 in the depicted example are a main memory 1208 and a graphics adapter 1210. The graphics adapter 1210 may be connected to a display 1211.

Other peripherals, such as a local area network (LAN)/Wide Area Network (WAN)/Wireless (e.g. WiFi) adapter 1212, may also be connected to the local system bus 1206. An expansion bus interface 1214 connects the local system bus 1206 to an input/output (I/O) bus 1216. The I/O bus 1216 is connected to a keyboard/mouse adapter 1218, a disk controller 1220, and an I/O adapter 1222. The disk controller 1220 may be connected to a storage 1226, which may be any suitable machine-usable or machine-readable storage medium, including, but not limited to, nonvolatile, hard-coded type mediums, such as read only memories (ROMs) or erasable, electrically programmable read only memories (EEPROMs), magnetic tape storage, and user-recordable type mediums, such as floppy disks, hard disk drives, and compact disk read only memories (CD-ROMs) or digital versatile disks (DVDs), and other known optical, electrical, or magnetic storage devices.

Storage 1226 can store any program code or data useful in performing processes as disclosed herein or for performing building automation tasks. In particular embodiments, storage 1226 can include such elements as room profile data 1252, sensor data 1254, operating tables 1256, and other data 1258, as well as a stored copy of BAS application 1228.

Also connected to the I/O bus 1216 in the example shown is an audio adapter 1224, to which speakers (not shown) may be connected for playing sounds. The keyboard/mouse adapter 1218 provides a connection for a pointing device (not shown), such as a mouse, trackball, trackpointer, etc. In some embodiments, the data processing system 1200 may be implemented as a touch screen device, such as, for example, a tablet computer or a touch screen panel. In these embodiments, elements of the keyboard/mouse adapter 1218 may be implemented in connection with the display 1211.

In various embodiments of the present disclosure, the data processing system 1200 can be used to implement as a workstation or as site controller 102 with all or portions of a BAS application 1228 installed in the memory 1208, configured to perform processes as described herein, and can generally function as the BAS described herein. For example, the processor 1202 executes program code of the BAS application 1228 to generate graphical interface 1230 displayed on display 1211. In various embodiments of the present disclosure, the graphical user interface 1230 provides an interface for a user to view information about and control one or more devices, objects, and/or points associated with the management system 100. The graphical user interface 1230 also provides an interface that is customizable to present the information and the controls in an intuitive and user-modifiable manner.

Those of ordinary skill in the art will appreciate that the hardware depicted in FIG. 12 may vary for particular implementations. For example, other peripheral devices, such as an optical disk drive and the like, also may be used in addition to or in place of the hardware depicted. The depicted example is provided for the purpose of explanation only and is not meant to imply architectural limitations with respect to the present disclosure.

One of various commercial operating systems, such as a version of Microsoft Windows™, a product of Microsoft Corporation located in Redmond, Wash., may be employed if suitably modified. The operating system may be modified or created in accordance with the present disclosure as described, for example, to implement discovery of objects and generation of hierarchies for the discovered objects.

The LAN/WAN/Wifi adapter 1212 may be connected to a network 1232, such as, for example, MLN 104 in FIG. 1. As further explained below, the network 1232 may be any public or private data processing system network or combination of networks known to those of skill in the art, including the Internet. Data processing system 1200 may communicate over network 1232 to one or more computers, which are also not part of the data processing system 1200, but may be implemented, for example, as a separate data processing system 1200.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of a system used herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

This application shares some subject matter in common with the following United States patent documents, each of which is hereby incorporated by reference:
U.S. Provisional Application 62/159,745, filed May 11, 2015;
U.S. Pat. No. 9,708,852, issued Jul. 18, 2017, and filed May 11, 2015; and
U.S. patent application Ser. No. 15/561,650.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

What is claimed is:

1. A method in a building automation system, the method performed by a data processing system and comprising:
determining anticipated area loads for a plurality of areas of a building;
analyzing the anticipated area loads with respect to a current weather condition and a short term weather forecasting;
identifying proactive control operating data in real time from an operating table for a heating plant and a cooling plant of the building based on the analysis; and
controlling the building automation system to adjust physical conditions of at least one area of the building to meet total anticipated area loads.

2. The method of claim 1, further comprising:
monitoring ongoing operating conditions and environmental conditions of the at least one area, the cooling plant and the heating plant;
updating area profile data for the at least one area according to the ongoing operating conditions and environmental conditions of the at least one area;
updating heating plant profile data for the plant according to the ongoing operating conditions of the heating plant; and
updating cooling plant profile data for the plant according to the ongoing operating conditions of the cooling plant.

3. The method of claim 2, wherein the heating plant profile data includes historical data for the heating plant, or the cooling plant profile data includes historical data for the cooling plant.

4. The method of claim 2, further comprising analyzing the heating plant profile data or the cooling plant profile data using one or more of machine learning, pattern recognition, or neural network techniques.

5. The method of claim 1, wherein controlling the building automation system includes determining desired occupant thermal comfort and visual comfort in the at least one area.

6. The method of claim 1, wherein controlling the building automation system is performed in real time is based on the anticipated area loads.

7. The method of claim 1, wherein controlling the building automation system includes at least one of performing chiller on/off sequences, performing boiler on/off sequences, adjusting cooling plant setpoints, or adjusting heating plant setpoints.

8. The method of claim 1, wherein the operating table includes operating condition data with respect to environmental and time conditions of the area, including one or more of time of day, day of week, day of year, weather, area occupation status, or sunshine conditions.

9. The method of claim 1, further comprising, for the at least one area of the building:
analyzing the area profile data for the area to produce an operating table for the at least one area;
identifying control operating data from the operating table for the at least one area based on the current weather condition and the short-term weather forecasting; and
controlling the building automation system to adjust physical conditions of the at least one area to meet occupant preference.

10. The method of claim 1, further comprising:
monitoring ongoing operating conditions and environmental conditions of the at least one area; and
updating the area profile data for the at least one area according to the ongoing operating conditions and environmental conditions of the area.

11. The method of claim 1, wherein controlling the building automation system to adjust physical conditions of at least one area is based on an occupancy schedule of the area.

12. The method of claim 1, wherein controlling the building automation system to adjust physical conditions of at least one area includes adjusting a temperature setpoint, adjusting a lighting level setpoint, adjusting a fresh air ventilation volume, adjusting a blind opening setpoint, or adjusting a blind angle setpoint.

13. The method of claim 1, wherein the area profile data for the at least one area includes historical data for the at least one area and future scheduling data for the at least one area.

14. The method of claim 1, wherein the area profile data for the at least one area includes historical data of the interaction between area occupants and the field device in the at least one area.

15. A building automation system comprising:
a processor; and
an accessible memory, wherein the building automation system is configured to:
determine anticipated area loads for a plurality of areas of a building;
analyze the anticipated area loads with respect to a current weather condition and a short term weather forecasting;
identify proactive control operating data in real time from an operating table for a heating plant and a cooling plant of the building based on the analysis; and
control the building automation system to adjust physical conditions of at least one area of the building to meet total anticipated area loads.

16. The building automation system of claim 15, wherein the building automation system is further configured to:
monitor ongoing operating conditions and environmental conditions of the at least one area, the cooling plant and the heating plant;
update area profile data for the at least one area according to the ongoing operating conditions and environmental conditions of the at least one area;
update heating plant profile data for the plant according to the ongoing operating conditions of the heating plant; and
update cooling plant profile data for the plant according to the ongoing operating conditions of the cooling plant.

17. The building automation system of claim 15, wherein the building automation system is further configured to, for the at least one area of the building:
analyze the area profile data for the area to produce an operating table for the at least one area;
identify control operating data from the operating table for the at least one area based on the current weather condition and the short term weather forecasting; and
control the building automation system to adjust physical conditions of the at least one area to meet occupant preference.

18. A non-transitory computer-readable medium encoded with executable instructions that, when executed, cause a building automation system to:
determine anticipated area loads for a plurality of areas of a building;
analyze the anticipated area loads with respect to a current weather condition and a short term weather forecasting;
identify proactive control operating data in real time from an operating table for a heating plant and a cooling plant of the building based on the analysis; and
control the building automation system to adjust physical conditions of at least one area of the building to meet total anticipated area loads.

19. The non-transitory computer-readable medium of claim 18, further comprising executable instructions that, when executed, cause the building automation system to:
monitor ongoing operating conditions and environmental conditions of the at least one area, the cooling plant and the heating plant;
update area profile data for the at least one area according to the ongoing operating conditions and environmental conditions of the at least one area;
update heating plant profile data for the plant according to the ongoing operating conditions of the heating plant; and
update cooling plant profile data for the plant according to the ongoing operating conditions of the cooling plant.

20. The non-transitory computer-readable medium of claim 18, further comprising executable instructions that, when executed, cause the building automation system to:
analyze the area profile data for the area to produce an operating table for the at least one area;
identify control operating data from the operating table for the at least one area based on the current weather condition and the short term weather forecasting; and
control the building automation system to adjust physical conditions of the at least one area to meet occupant preference.
